(19) United States
(12) Patent Application Publication
(10) Pub. No.: US 2026/0221811 A1
(43) Pub. Date: Jul. 30, 2026

(54) WAVEFORM FOR WIRELESS POWER TRANSFER WITH MULTIPLE ANTENNAS

(71) Applicant: Sony Group Corporation, Tokyo (JP)

(72) Inventors: Nafiseh Seyed MAZLOUM, Lund (SE); Ove EDFORS, Södra Sandby (SE)

(21) Appl. No.: 19/148,815

(22) PCT Filed: Jan. 25, 2024
(86) PCT No.: PCT/EP2024/051762

§ 371 Date: Jul. 17, 2025

(30) Foreign Application Priority Data
Jan. 31, 2023 (SE) 2350089-5

(51) Int. Cl. H02J 50/80; H02J 50/20; H02J 50/40

(52) U.S. Cl. CPC H02J 50/80; H02J 50/20; H02J 50/402

(57) ABSTRACT

Examples propose a method performed by a power transmitting device for wirelessly supplying power to a power receiving device of a communication network, the power transmitting device comprising M antennas, the method comprising: obtaining (310), for each of the M antennas, K subcarrier channel estimates hₘₖ (m=1 . . . . M; k=1 . . . . K) associated with K subcarrier radio channels to the power receiving device; selecting (320), based on the obtained K subcarrier channel estimates hₘₖ, one single subcarrier radio channel of the K subcarrier radio channels per antenna; and transmitting (330), within a predefined time window, a power signal comprising one single tone per antenna on the selected subcarrier radio channel via the associated antennas, wherein the phases of the transmitted tones are selected based on the phases of the subcarrier channel estimates. Furthermore, examples disclose a power transmitting device.

### TECHNICAL FIELD

Various examples generally relate to wirelessly transmitting power from a power transmitting device to a power receiving device.

### BACKGROUND

Modern data transmission relies to a large extend on wireless communication. Conventional radio communication requires transmitting devices to generate radio signals using components such as digital-to-analog converters (DACs), mixers, oscillators and power amplifiers and receiving devices using components low noise amplifiers, mixers, oscillators, and analog-to-digital converters (ADCs) to receive the radio signals. Usually, devices participating in wireless communication are battery powered and the aforementioned components for wireless communication consume a substantial amount of the energy provided by the battery. Hence, the batteries will have to be recharged or replaced regularly. With an increasing amount of battery powered devices participation in wireless communication, this may not be feasible anymore. For example, a number of one trillion Internet-of-things (IoT) devices worldwide each having a 10-year battery lifetime would already imply that 274 billion batteries would have to be changed every single day. However, in several use cases a 10-year battery lifetime may not even be achievable with known technologies.

Moreover, battery recycling is still insufficient. In 2018, 191 000 tons of portable batteries were sold in the European Union but only less than half of said quantity, i.e. 88 000 tons of used portable batteries, is collected as waste to be recycled. The demand for new batteries has to be reduced, too, in view of the limited natural resources required for battery production.

To allow a long-life and maintenance-free IoT network, some IoT devices are equipped with rechargeable energy storage devices such as rechargeable batteries, super capacitors or capacitors. Ambient energy such as light, electromagnetic radiation, thermal energy resources or dedicated energy such as electrostatic, acoustic, magnetic or electromagnetic radiation may be used to charge/re-charge these rechargeable batteries, super capacitors or capacitors. Among these energy resources, electromagnetic radiation, which is primarily used for communication, known as far-field wireless power transfer (WPT) is one of the promising solutions foreseen for future ultra-low power and small form factor IoT devices. WPT may be easily controllable and available on demand. In contrast to other energy resources, no extra bulky component may be required for converting the RF signal to power. Hence, WPT may be very suitable for devices with a small form factor. Some methods for of WPT have been proposed by Zeng, Y., Clerckx, B., & Zhang, R. (2017). Communications and signals design for wireless power transmission. IEEE Transactions on Communications, 65(5), 2264-2290 and Ayir, N., Riihonen, T., Allen, M., & Fierro, M. F. T. (2021). Waveforms and end-to-end efficiency in RF wireless power transfer using digital radio transmitter. IEEE Transactions on Microwave Theory and Techniques, 69(3), 1917-1931.

### SUMMARY

There is a need to for high end-to-end power transfer efficiency, i.e., the ratio of the DC power received at the receiver to the DC power at the transmitter.

Said need has been addressed with the subject-matter of the independent claims. Advantageous embodiments are described in the dependent claims.

Examples provide a method ##Examples provide a power transfer device ##

### BRIEF DESCRIPTION OF THE DRAWINGS

FIG. 1 schematically illustrates a WPT system.

FIG. 2 shows an illustration of a rectifier efficiency as a function of input amplitude.

FIG. 3 is a flow chart illustrating a method for wirelessly supplying power.

FIG. 4-9 illustrates tones transmitted via different subcarriers radio channels.

FIG. 10 illustrates amplitude over time of a power signal.

FIG. 11 illustrates amplitude over time of a power signal.

FIG. 12 illustrates power over time of the power signal of FIG. 10.

FIG. 13 illustrates power over time of the power signal of FIG. 11.

FIG. 14 illustrates power transmission efficiency.

### DETAILED DESCRIPTION

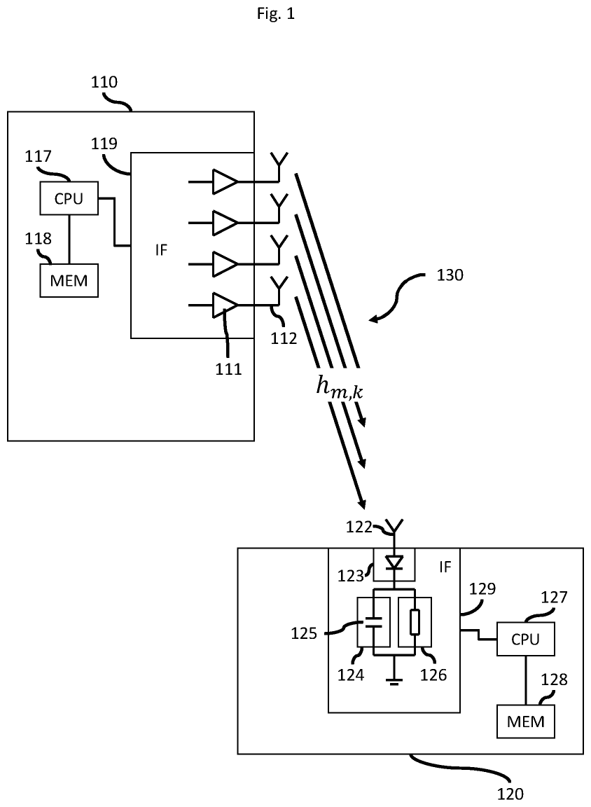

FIG. 1 shows a very general block diagram of a WPT system comprising of a power transmitting device 110, and a power receiving device 120. The power transmitting device 110 and the power receiving device 120 are part of a communication network. At the power transmitting device 110, the DC (or low-frequency) signal is up-converted into a target radio frequency, amplified by power amplifiers 111 and radiated as power signal 130 by transmitting antennas 112 of the power transmitting device 110. The power signal 130 is then propagating through radio channels, picked up by one or more receiving antennas 122 of the power receiving device 120, converted into a usable direct current (DC) via components such as rectifiers 123, and finally stored in a storage unit 124 such as a battery or a capacitor 125. The stored power/energy may then be used by a load 126 of the power receiving device 120.

The end-to-end power transfer efficiency depends on efficiencies of DC to radio frequency (RF) conversion at the power transmitting device 110, the RF transmission over the radio channels, and the RF to DC conversion at the power receiving device 120.

The power transmitting device 110 may further comprise control circuitry. The control circuitry may comprise a processor 117 and a memory 118 coupled to the processor 117. The control circuitry may be used to control the interface 119 comprising the power amplifier 111 connected to the antenna 112.

Likewise, the power receiving device 120 may comprise control circuitry. The control circuitry may comprise a processor 127 and a memory 128 coupled to the processor 127. The control circuitry may be used to control the interface 129.

The power transmitting device 110 may comprise more antennas than actually used for transmitting the power signal 130. In some scenarios, the power transmitting device 110 may use more antennas for transmitting the power signal 130 than in other scenarios.

In some scenarios, a communication network may comprise several communication nodes communicating according to a predefined protocol wherein the communication nodes comprise the power transmitting device 110 and/or the power receiving device 120. The predefined protocol may be a protocol as specified by 3GPP or IEEE.

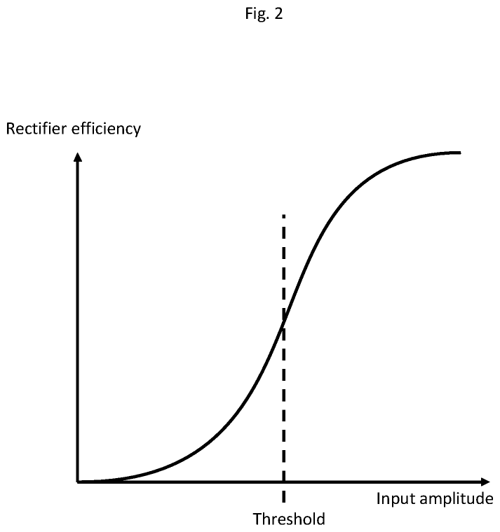

FIG. 2 shows an illustration of a rectifier efficiency as a function of input amplitude. Due to non-linear characteristics of the rectifier, in order to achieve a high rectifier efficiency, it may be advantageous if the power signal delivering the energy is designed such that the energy is concentrated in the received power signal, and conversions happens at high amplitude. Multi-tone waveforms have been proposed to create power signals with high peaks. However, the efficiency of power amplifiers used by the power transmitting device for the RF transmission typically decreases when the power signal comprises high peaks.

Thus, optimizing end-to-end power transfer efficiency, i.e., the ratio of the DC power received at the power receiving device 120 to the power transmitted by the power transmitting device 110, is a very important and at the same time very challenging task when designing WPT systems.

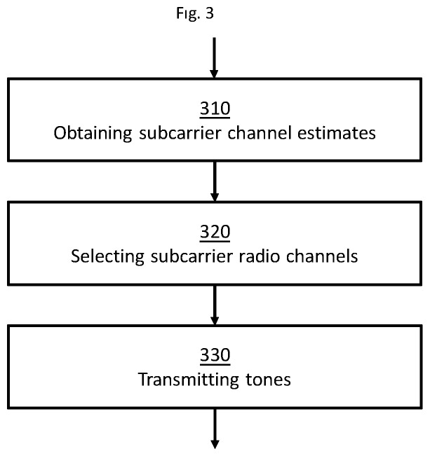

Examples disclosed herein provide a method performed by a power transmitting device for wirelessly supplying power to a power receiving device of a communication network as illustrated in FIG. 3. The power transmitting device comprises M antennas.

At 310, the method prescribes obtaining, for each of the M antennas, K subcarrier channel estimates hₘₖ (m=1 . . . . M; k=1 . . . . K) associated with K subcarrier radio channels to the power receiving device. In other words, for each of the M antennas a channel estimate is obtained. This may be done by transmitting a reference signal from the power receiving device that can be used to estimate the uplink channel which in case of TDD may be the same as the downlink channel. In case of FDD, correlation between the duplex bands may be used to obtain the channel estimate. It may also be conceivable to obtain channel estimates through environment learning. In some scenarios, previously determined channel estimates may be used. For example, channel estimates may have been used to optimize data communication between the power transmitting device and the power receiving device.

Based on the obtained K subcarrier channel estimates hₘₖ, one single subcarrier radio channel of the K subcarrier radio channels per antenna is selected (320). In other words, the single subcarriers are selected based on their individual contribution to the collective amount of harvested energy at the power receiving device for the obtained channel estimates.

Then, at 330, the method prescribes transmitting within a predefined time window a power signal comprising one single tone per antenna on the selected subcarrier radio channel. In other words one tone is transmitted via each antenna. A frequency of the tone depends on the subcarrier radio channel selected in 320 for the respective antenna.

A tone may correspond to a sinusoid signal with a single frequency. The phases of the transmitted tones are selected based on the phases of the subcarrier channel estimates. In some examples, the predefined time window may correspond to a number of radio frames. Some scenarios may prescribe that the predefined time window corresponds to one or more OFDM symbols. The predefined time window may be selected according to a predefined rule. In some scenarios, the predefined time window may be selected to a time variation characteristic of the subcarrier radio channels. In particular, the predefined time window may be selected to be longer than a time period over which the subcarrier radio channels can be considered static. The predefined time window may correspond to a time period over which the same transmission settings may be kept.

As also illustrated in FIG. 1, one antenna 112 comprises a single power amplifier 111 connected to one or more antenna elements. In some examples, an antenna port may be called antenna.

The proposed method may allow for building, in some examples in real-time, efficient energy-transfer waveforms for multiple antennas, which may be furthermore adapted to current channel conditions. Thus, for an improved end-to-end conversion efficiency, an end-to-end design with jointly optimized transmission, wireless propagation and reception is proposed. The proposal may be considered as a very practical solution with low complexity for a challenging optimization problem.

Typically, a discrete set of frequencies within a certain bandwidth may be used for the transmission of a power signal. Orthogonal frequency-division multiplexing (OFDM) systems are a common system type and OFDM subcarriers may be considered a good representative of a discrete set of frequencies. In particular, OFDM subcarriers may be considered a good representative of a discrete set of tones. An OFDM-based power transmitting system may use K subcarriers and a power transmission device of such a system may comprise M antennas.

Subcarrier channel estimates for the subcarrier channels from each antenna to the power receiving device may be. Said subcarrier channel estimates may have been obtained through a known channel acquisition procedure. h_{m,k}. may be the subcarrier channel estimate from antenna m on subcarrier k. h_{m,k}. may also be called channel coefficient. Each antenna of the power transmitting device may be fed by a power amplifier, i.e., a transmitter chain with limited maximum instantaneous amplitude A.

Excluding any cyclic prefix, the transmitted base-band power signal during a single OFDM symbol from antenna m is

$${s}_{m} ( n ) = {\sum }_{k = 1}^{K} {x}_{m , k} {e}^{j 2 π \frac{k n}{K}} ,$$

where n=0, . . . , K−1, and x_{m,k} is the complex-valued coefficient representing the amplitude and phase transmitted on the m-th antenna and k-th subcarrier channel. Further, the power amplifier at each transmit antenna may have a limited maximum amplitude and to avoid clipping of the signal and the associated out of band emissions, the peak transmitted amplitude may be considered to be limited to

$${max}_{n} \vert {s}_{m} ( n ) \vert \leq A$$

for all transmitters m.

The received power signal after going through the respective channel becomes

$${y}_{m} ( n ) = {\sum }_{k = 1}^{K} {h}_{m , k} {x}_{m , k} {e}^{j 2 π \frac{k n}{K}} ,$$

where, again, n=0, . . . , K−1. This makes the total received power signal from all M antennas

$$y ( n ) = {\sum }_{m = 1}^{M} {y}_{m} ( n ) = {\sum }_{m = 1}^{M} {\sum }_{k = 1}^{K} {h}_{m , k} {x}_{m , k} {e}^{j 2 π \frac{k n}{K}} ,$$

To restrict peak amplitude variations at the antennas of the power transmitting device, transmission may be performed on only one subcarrier per antenna. For that selected subcarrier κₘ of antenna m the respective portion of the transmitted power signal becomes a x_{m,κ}_{ₘ}=Ae^{jφm} and x_{m,k}=0 for all other values of k.

Hence, the transmitted power signal becomes

$${s}_{m} ( n ) = {x}_{m , {κ}_{m}} {e}^{j 2 π \frac{{κ}_{m} n}{K}} = A {e}^{j {φ}_{m}} {e}^{j 2 π \frac{{κ}_{m} n}{K}}$$

with

$${max}_{n} \vert {s}_{m} ( n ) \vert = A .$$

Correspondingly, the received power signal then becomes

$$y ( n ) = A {\sum }_{m = 1}^{M} {h}_{m , {κ}_{m}} {e}^{j {φ}_{m}} {e}^{j 2 π \frac{{κ}_{m} n}{K}}$$

In order to obtain an amplitude as high as possible at the power receiving device for operating the rectifier of the power receiving device with high efficiency, the used subcarrier κₘ on antenna m may be selected to be the one with the strongest subcarrier channel estimate to the power receiving device, i.e.,

$${κ}_{m} = {arg max}_{κ} \vert {h}_{m , κ} \vert .$$

Further, all terms in the sum may be selected to have a common phase, i.e.,

$$∠ {h}_{m , {κ}_{m}} + {φ}_{m} + 2 π \frac{{κ}_{m} {n}_{o}}{K} = constant$$

where the constant value is arbitrary and for instance can be equal to zero, which gives

$${φ}_{m} = - ∠ {h}_{m , {κ}_{m}} - 2 π \frac{{κ}_{m} {n}_{o}}{K} ,$$

Hence, the terms of the sum may add up constructively at, at least one, time instant no.

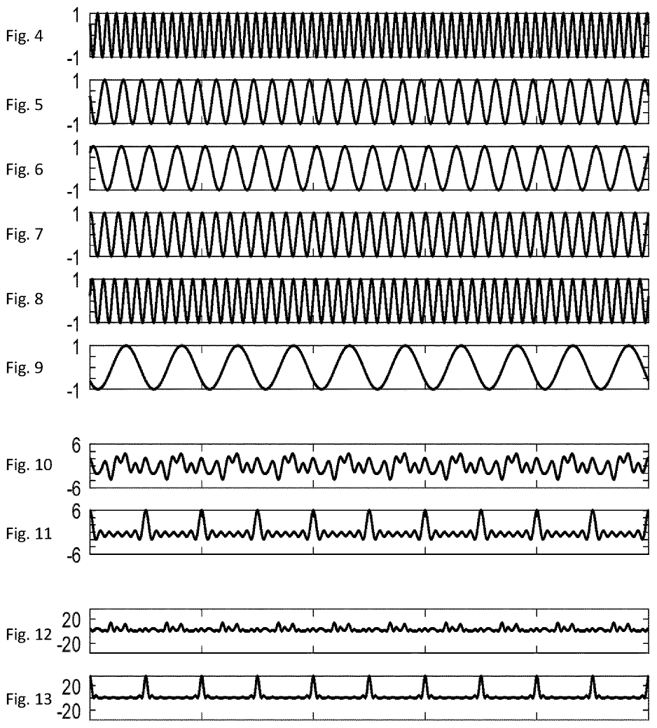

FIGS. 4 to 11 illustrate the advantage of suitably selecting the phases of the tones to be submitted via the respective subcarrier channels. FIGS. 4 to 9 show amplitudes over times of tones submitted on different subcarrier channels, i.e. having different frequencies.

FIGS. 10 and 12 show exemplary amplitude and power of a power signal resulting from the tones shown in FIGS. 4 to 9, if the phase of the respective subcarrier channel estimate is not taken into account when transmitting the tones via the antennas.

FIGS. 11 and 13 show amplitude and power of a power signal resulting from the tones shown in FIGS. 4 to 9, if the phase of the respective subcarrier channel estimate is taken into account when transmitting the tones via the antennas.

As shown amplitude and power shown in FIGS. 11 and 13 feature significantly more pronounced peaks facilitating power harvesting due to a higher efficiency of the rectifier of the power receiving device.

Accordingly, the proposed design may lead to a high transmission efficiency and high reception efficiency in OFDM based multiple-input and multiple-output (MIMO) systems.

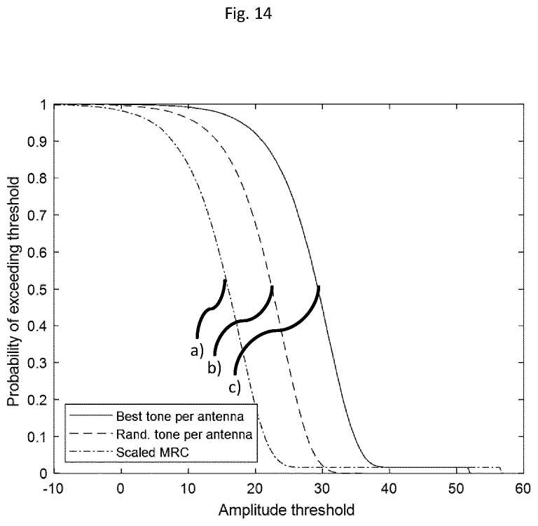

FIG. 14 further illustrates advantageous of the proposed approach. FIG. 3 illustrates complementary CDFs (CCDFs) of received amplitude at the power receiving device for three methods. In all cases, the power receiving device comprises 128 antennas and 64 OFDM subcarrier channels are used. The CCDFs are generated under the assumption of IID Rayleigh-fading channel coefficients.

Curve a) shows a classic maximum-ratio transmission. Curve b) shows the transmission of single tones on a single subcarrier channel per antenna, wherein the subcarrier channel used by each antenna and the phase of each tone is selected randomly. Finally curve c) shows the approach shown above. In all cases, the maximum amplitude at each antenna element is selected to have the same level.

The proposed power signal c) outperforms the other two approaches by about 7 and 14 dB.

Summarizing, at least the following EXAMPLES have been described above:

EXAMPLE 1. Method performed by a power transmitting device for wirelessly supplying power
to a power receiving device of a communication network,
the power transmitting device comprising M antennas,
the method comprising:
   obtaining (310), for each of the M antennas, K subcarrier channel estimates hₘₖ (m=1 . . . . M; k=1 . . . . K) associated with K subcarrier radio channels to the power receiving device;
   selecting (320), based on the obtained K subcarrier channel estimates hₘₖ, one single subcarrier radio channel of the K subcarrier radio channels per antenna,
   transmitting (330), within a predefined time window, a power signal comprising one single tone per antenna on the selected subcarrier radio channel,
wherein the phases of the transmitted tones are selected based on the phases of the subcarrier channel estimates.

EXAMPLE 2. Method of EXAMPLE 1,
wherein the phases of the transmitted tones are selected such that the peak power of the power signal received at the power receiving device is larger than the sum of powers of the individual single tones, had they been received individually at the power receiving device.

EXAMPLE 3. Method of EXAMPLE 1 or 2,
wherein the phases of the transmitted tones are selected for the single tones to add constructively at the power receiving device.

EXAMPLE 4. Method of any one of EXAMPLEs 1 to 3,
wherein the predefined time window corresponds to one or more of
   a number of radio frames,
   one or more OFDM symbols

EXAMPLE 5. Method of any one of EXAMPLEs 1 to 4,
wherein one antenna comprises a single power amplifier connected to one or more antenna elements.

EXAMPLE 6. Power transmitting device for wirelessly supplying power to a power receiving
device of a communication network,
wherein the power transmitting device comprises M antennas,
wherein the power transmitting device comprises control circuitry,
wherein the control circuitry is configured for
   obtaining (310), for each of the M antennas, K subcarrier channel estimates hₘₖ (m=1 . . . . M; k=1 . . . . K) associated with K subcarrier radio channels to the power receiving device;
   selecting (320), based on the obtained K subcarrier channel estimates hₘₖ, one single subcarrier radio channel of the K subcarrier radio channels per antenna; and
   transmitting (330), within a predefined time window, a power signal comprising one single tone per antenna on the selected subcarrier radio channel via the associated antennas,
wherein the phases of the transmitted tones are selected based on the phases of the subcarrier channel estimates.

EXAMPLE 7. Power transmitting device of EXAMPLE 6,
wherein the phases of the transmitted tones are selected such that the peak power of the power signal received at the power receiving device is larger than the sum of powers of the individual single tones, had they been received individually at the power receiving device.

EXAMPLE 8. Power transmitting device of EXAMPLE 6 or 7,
wherein the phases of the transmitted tones are selected for the single tones to add constructively at the power receiving device.

EXAMPLE 9. Power transmitting device of any one of EXAMPLEs 6 to 8,
wherein the predefined time window corresponds to one or more of
   a number of radio frames,
   one or more OFDM symbols.

EXAMPLE 10. Power transmitting device of any one of EXAMPLEs 6 to 9,
wherein one antenna comprises a single power amplifier connected to one or more antenna elements.

EXAMPLE 11. Power transmitting device for wirelessly supplying power to a power receiving
device of a communication network,
wherein the power transmitting device comprises M antennas,
wherein the power transmitting device comprises control circuitry,
wherein the control circuitry is configured for performing the method of any one of EXAMPLEs 1 to 5.

1. A method performed by a power transmitting device for wirelessly supplying power to a power receiving device of a communication network, the power transmitting device comprising M antennas, the method comprising:
obtaining, for each of the M antennas, K subcarrier channel estimates hₘₖ (m=1 . . . M; k=1 . . . k) associated with K subcarrier radio channels to the power receiving device;
selecting, based on the obtained K subcarrier channel estimates hₘₖ, one single subcarrier radio channel of the K subcarrier radio channels per antenna,
transmitting, within a predefined time window, a power signal comprising one single tone per antenna on the selected subcarrier radio channel,
wherein the phases of the transmitted tones are selected based on the phases of the subcarrier channel estimates.

2. The method of claim 1,
wherein the phases of the transmitted tones are selected such that the peak power of the power signal received at the power receiving device is larger than the sum of powers of the individual single tones, had they been received individually at the power receiving device.

3. The method of claim 1,
wherein the phases of the transmitted tones are selected for the single tones to add constructively at the power receiving device.

4. The method of claim 1,
wherein the predefined time window corresponds to one or more of:
a number of radio frames,
one or more OFDM symbols

5. The method of claim 1,
wherein one antenna comprises a single power amplifier connected to one or more antenna elements.

6. A power transmitting device for wirelessly supplying power to a power receiving device of a communication network,
wherein the power transmitting device comprises M antennas,
wherein the power transmitting device comprises control circuitry,
wherein the control circuitry is configured for
obtaining, for each of the M antennas, K subcarrier channel estimates hₘₖ (m=1 . . . M; k=1 . . . k) associated with K subcarrier radio channels to the power receiving device;
selecting, based on the obtained K subcarrier channel estimates hₘₖ, one single subcarrier radio channel of the K subcarrier radio channels per antenna; and
transmitting, within a predefined time window, a power signal comprising one single tone per antenna on the selected subcarrier radio channel via the associated antennas, wherein the phases of the transmitted tones are selected based on the phases of the subcarrier channel estimates.

7. The power transmitting device of claim 6,
wherein the phases of the transmitted tones are selected such that the peak power of the power signal received at the power receiving device is larger than the sum of powers of the individual single tones, had they been received individually at the power receiving device.

8. The power transmitting device of claim 6,
wherein the phases of the transmitted tones are selected for the single tones to add constructively at the power receiving device.

9. The power transmitting device of claim 6,
wherein the predefined time window corresponds to one or more of:
a number of radio frames,
one or more OFDM symbols.

10. The power transmitting device of claim 6,
wherein one antenna comprises a single power amplifier connected to one or more antenna elements.

11. A power transmitting device for wirelessly supplying power to a power receiving device of a communication network,
wherein the power transmitting device comprises M antennas,
wherein the power transmitting device comprises control circuitry,
wherein the control circuitry is configured for performing the method of claim 1.
